(19) United States
(12) Patent Application Publication
(10) Pub. No.: US 2025/0299140 A1
(43) Pub. Date: Sep. 25, 2025

(54) LONG-SHORT FIELD MEMORY NETWORKS

(71) Applicant: ADP, Inc., Roseland, NJ (US)

(72) Inventors: Allan Barcelos, Porto Alegre (BR); Leandro Bianchini, Porto Alegre (BR); Fernanda Tosca, Porto Alegre (BR)

(73) Assignee: ADP, Inc., Roseland, NJ (US)

(21) Appl. No.: 19/233,648

(22) Filed: Jun. 10, 2025

Related U.S. Application Data
(63) Continuation of application No. 17/071,135, filed on Oct. 15, 2020.

(51) Int. Cl. G06Q 10/0637; G06F 3/0482; G06N 3/045; G06N 3/08; G06N 20/00

(52) U.S. Cl. CPC G06Q 10/0637; G06F 3/0482; G06N 3/045; G06N 3/08; G06N 20/00

(57) ABSTRACT

Technical solutions provide a processor to identify a subset of data fields for inclusion into an electronic data structure and a sequential order in which the data fields are selected. The processor can determine a context of the electronic data structure based on the identified subset and the sequential order and identify, using the determined context, an index for an existing electronic data structure. The processor can retrieve values corresponding to the additional data fields of the existing data structure and include, in the electronic data structure, the additional data fields and the retrieved values to create an updated electronic data structure. The processor can cause display of the additional data fields for the updated electronic data structure, generate the updated electronic data structure including the selected additional data field and a retrieved value and cause display of the updated electronic data structure in accordance with the selection.

### CROSS-REFERENCE TO RELATED APPLICATIONS

This application claims the benefit and priority under 35 U.S.C. § 120 as a continuation of U.S. patent application Ser. No. 17/071,135, filed Oct. 15, 2020 and titled “Long-Short Field Memory Networks”, which is hereby incorporated by reference herein in its entirety and for all purposes.

### BACKGROUND INFORMATION

### Field

The present disclosure relates generally to an improved computer system and, in particular, to a method and apparatus for managing reports. Still more particularly, the present disclosure relates to a method and apparatus for creating new reports for applications.

### Background

Information systems are used for many different purposes. The different operations performed using the information system may be referred to as transactions. For example, an information system may be used to process payroll to generate paychecks for employees in an organization. The different operations performed to generate paychecks for a pay period using the information system may be referred to as a transaction.

Additionally, an information system also may be used by a human resources department to maintain benefits and other records about employees. For example, a human resources department may manage health insurance, wellness plans, and other programs in an organization using an employee information system. As yet another example, an information system may be used to determine when to hire new employees, assign employees to projects, perform reviews for employees, and other suitable operations for the organization.

Other uses of information systems include purchasing equipment and supplies for an organization. In yet another example, information systems may be used to plan and rollout a promotion of a product for an organization.

Often times, an operator may desire to generate a report for a particular type of transaction. Currently, the operator may use report generator software to generate reports that are human readable from different sources such as databases in the information systems. Currently available report generator software are often more difficult to use than desired.

This type of software requires the operator to have knowledge about how information is stored to select what information to use in a report. For example, the operator may need to know what fields, tables, or columns in the database should be selected for including desired information in the report.

As a result, an operator may need to have experience or training with respect to report generator software and databases in addition to the experience and training to perform the transaction for which the report is being generated. This additional skill may limit the number of operators who are able to generate reports. Additionally, operators who do not generate reports very often may find that report generating may take more time and may be more difficult than desired.

Therefore, it would be desirable to have a method and apparatus that take into account at least some of the issues discussed above, as well as other possible issues. For example, it would be desirable to have a method and apparatus that overcome the technical problem with operators being unable to generate reports as efficiently as desired without knowledge about how the information is stored.

### SUMMARY

An embodiment of the present disclosure provides a computer-implemented a method for generating reports. A subset of data fields is identified for inclusion in a new report. A context of the new report is determined based on the subset and a sequence in which the data fields of the subset were identified. Using a machine learning model, a set of suggested fields is determined based on the context of the new report. The set of the suggested fields in a graphical user interface on a display system.

Another embodiment of the present disclosure provides a system for generating reports. The system comprises a bus system and a storage device connected to the bus system. The storage device stores program instructions that are executed by a number of processors. The number of processors execute the program instructions to identify a subset of data fields for inclusion in a new report. The number of processors further execute the program instructions to determine a context of the new report based on the subset and a sequence in which the data fields of the subset were identified. The number of processors further execute the program instructions to determine a set of suggested fields based on the context of the new report. The set of suggested fields can be determined Using a machine learning model. The number of processors further execute the program instructions to display the set of the suggested fields in a graphical user interface on a display system.

Another embodiment of the present disclosure provides a computer program product for managing reports. The computer program product comprises a computer readable storage media and program code stored thereon. The program code includes code for collecting existing reports. The program code further includes code for identifying a subset of data fields for inclusion in a new report. The program code further includes code for determining a context of the new report. The context is determined based on the subset and a sequence in which the data fields of the subset were identified. The program code further includes code for determining a set of suggested fields based on the context of the new report. The set of suggested fields can be determined using a machine learning model. The program code further includes code for displaying the set of the suggested fields in a graphical user interface on the display system.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems depicted in which illustrative embodiments may be implemented;

FIG. 2 is a block diagram of report management environment depicted in accordance with an illustrative embodiment;

FIG. 3 is a diagram that illustrates a node in a neural network in which illustrative embodiments can be implemented;

FIG. 4 is a diagram illustrating a neural network in which illustrative embodiments can be implemented;

FIG. 5 is an example of a recurrent neural network in which illustrative embodiments can be implemented;

FIG. 6 is a process for scoring features of existing reports depicted according to an illustrative example;

FIG. 7 is a process for predicting a context for a new report depicted according to an illustrative example;

FIG. 8 is a process for generating a new report is depicted according to an illustrative example;

FIG. 9 an illustration of a block diagram of a data processing system is depicted in accordance with an illustrative embodiment;

FIG. 10 is a process for generating a set of suggested fields in real time; and

FIG. 11 is an illustration of a block diagram of a data processing system is depicted in accordance with an illustrative embodiment.

### DETAILED DESCRIPTION

The illustrative embodiments recognize and take into account one or more different considerations. For example, the illustrative embodiments recognize and take into account that the process currently used to generate reports may be more cumbersome and difficult than desired. For example, an operator, who desires to generate a report for a transaction being performed using an application, exits or leaves the application and starts a new application for generating reports, such as currently used report generator software.

The illustrative embodiments also recognize and take account that currently available report generator software uses the names of columns, fields, tables, or other data structures in presenting selections to an operator. The illustrative embodiments recognize and take into account that often times, the names used in a database may not be the same as the name of the field as displayed in the application used by the operator to perform the transaction.

Thus, those embodiments provide a method and apparatus for managing reports. In particular, a method may be present that helps an operator generate a new report more quickly and easily as compared to currently available report generator software.

In one illustrative example, a method is present a computer-implemented a method for generating reports. A subset of data fields is identified for inclusion in a new report. A context of the new report is determined based on the subset and a sequence in which the data fields of the subset were identified. Using a machine learning model, a set of suggested fields is determined based on the context of the new report. The set of the suggested fields in a graphical user interface on a display system.

As used herein, “a group of,” when used with reference to items, means one or more items. For example, “a group of reports” is one or more reports. Further, “a number of,” when used with reference to items, means one or more items. For example, “a group of contexts” is one or more contexts.

A field is a space that holds a piece of data. The space may be, for example, in a location in a record for a database. As another example, the space may be in a location of memory of a computer system. When the space is in an application, the space may be in a data structure in the application.

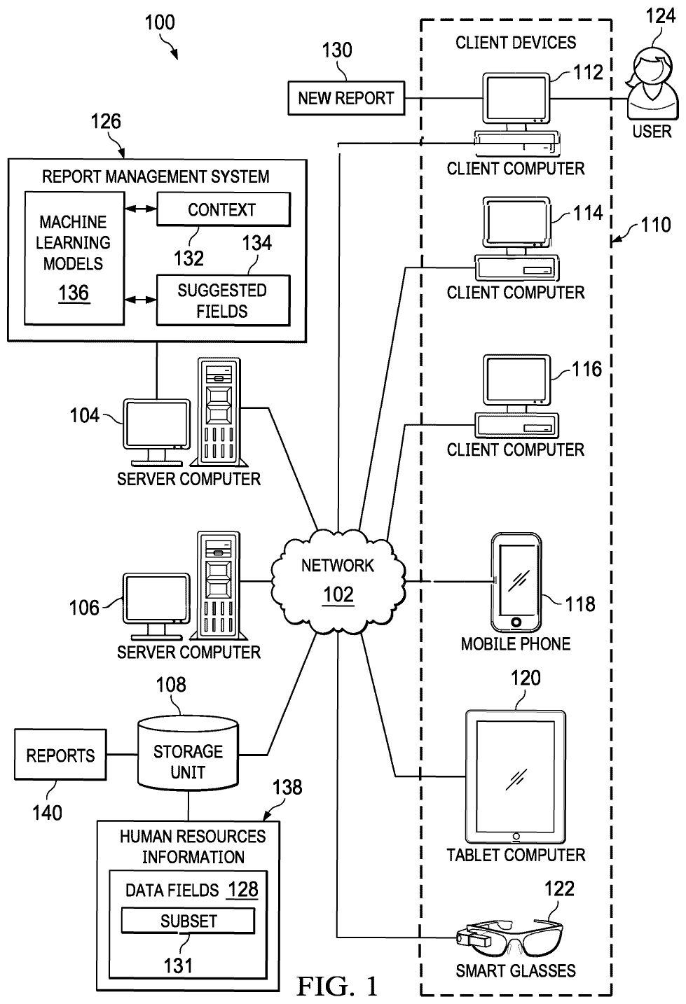

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet-of-things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of,” when used with reference to items, means one or more items. For example, “a number of different types of networks” is one or more different types of networks.

Further, the phrase “a set of” or “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item Band item C. Of course, any combinations of these items can be present. In some illustrative examples, “at least one of” can be, for example, without limitation, two of item A; one of item B; and ten of item C; four of item Band seven of item C; or other suitable combinations.

In this illustrative example, user 124 can use client computer 112 to interact with report management system 126. Report management system 126 is an application for creating and managing reports 140. Every report created by report management system 126 has a purpose and an objective, which leads to the intention of the report owner.

In this illustrative example, report management system 126 identifies a subset 131 of data fields 128 for inclusion in a new report 130. Data fields 128 are spaces for pieces of data. For example, in a relational database table, the columns of the table are the fields. The rows of the table are records. The records in the table are values for the fields. Fields are spaces where pieces of data are located. These pieces of data are used to perform transactions. Data stored in data fields 128 can be human resources information 138 generated in providing human resources services. For example, in a payroll application, the fields can include at least one of salary, tax information, benefits information, or other suitable types of payroll data.

The sheer number of fields in some data sets sometimes makes the users struggle with traditional reporting applications, and could lead them to be confused about which fields, filters, derived or calculated fields they should select. However, users typically know their report subject (context) and what kind of information they want put into a report.

In this illustrative example, report management system 126 determines context 132 of the new report 130. Context 132 is the intent of a report, such as new report 130. Context 132 provides relevant information about the entire report, and characterizes the intention of the report. In this illustrative example, report management system 126 determines context 132 based on the subset 131 of data fields 128 identified for inclusion in new report 130, and a sequence in which the subset 131 of the data fields 128 were identified.

In this illustrative example, report management system 126 determines set of suggested fields 134 based on the context 132 of the new report 130. For example, using one or more machine learning models 136, report management system 126 can determine suggested fields 134 based on context 132 of new report 130. When trained, each of machine learning models 136 can be used to identify suggested fields 134 from data fields 128. For example, one or more machine learning models 136 can take context 132 as input, and probabilistically determine which of data fields 128 are likely to be selected for inclusion in new report 130. Report management system 126 can then display the set of the suggested fields 134 in a graphical user interface of a display system, such as on client computer 112.

When machine learning models 136 are included in report management system 126, report management system 126 provides a technical solution that overcomes a technical problem of quickly and easily generating new reports. Report management system 126 identify suggested fields 134 based on the context 132 of the new report 130, enabling user 124 to create new report 130 more easily and quickly. As a result, this technical solution to the technical problem of generating reports provides a technical effect in which a new reports are generated more easily and quickly while requiring less knowledge or training from an operator.

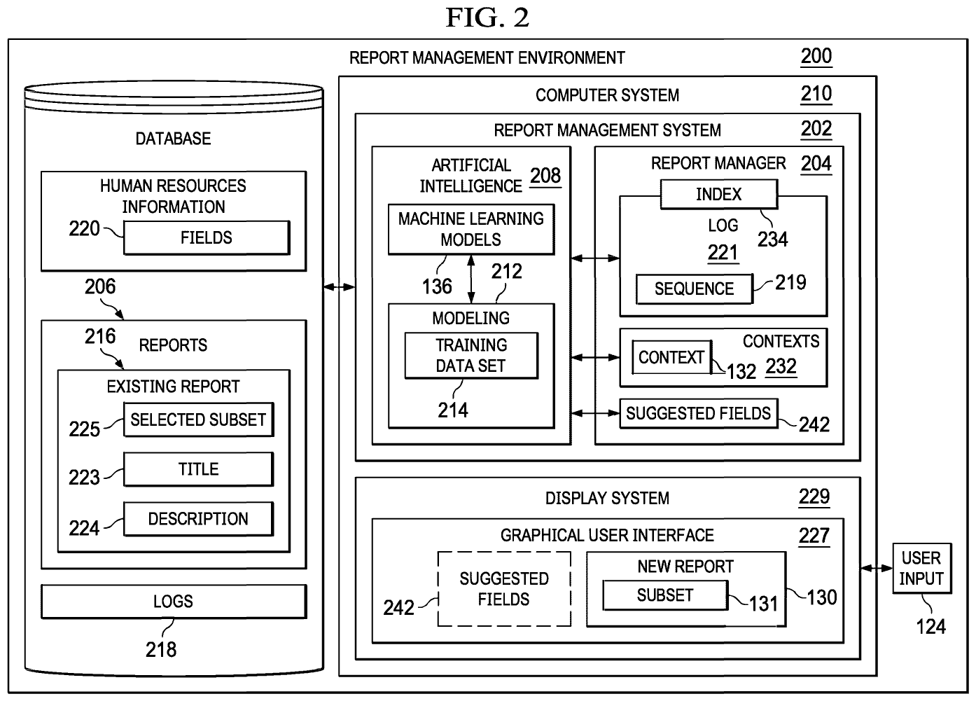

With reference now to FIG. 2, a block diagram of report management environment is depicted in accordance with an illustrative embodiment. In this illustrative example, report management environment 200 includes components that can be implemented in hardware such as the hardware shown in network data processing system 100 in FIG. 1.

As depicted, report management environment 200 is an environment in which report management system 202 provides services for generating new report 130. As depicted, report management environment 200 includes report management system 202. Report management system 202 is an example of report management system 126 of FIG. 1.

In this illustrative example, report manager 204 in report management system 202 operates to generate reports 206 using artificial intelligence 208. In this illustrative example, artificial intelligence 208 can be used to more efficiently generate reports 206 as compared to other report management systems that do not have artificial intelligence 208.

Report manager 204 can be implemented in software, hardware, firmware or a combination thereof. When software is used, the operations performed by report manager 204 can be implemented in program code configured to run on hardware, such as a processor unit. When firmware is used, the operations performed by report manager 204 can be implemented in program code and data and stored in persistent memory to run on a processor unit. When hardware is employed, the hardware may include circuits that operate to perform the operations in report manager 204.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

An artificial intelligence system, such as artificial intelligence 208, is a system that has intelligent behavior and can be based on function of the human brain. An artificial intelligence system comprises at least one of an artificial neural network, and artificial neural network with natural language processing, a cognitive system, a Bayesian network, a fuzzy logic, an expert system, a natural language system, a cognitive system, or some other suitable system.

Machine learning is used to train the artificial intelligence system. Machine learning involves inputting data to the process and allowing the process to adjust and improve the function of the artificial intelligence system.

A cognitive system is a computing system that mimics the function of a human brain. The cognitive system can be, for example, IBM Watson available from International Business Machines Corporation.

In this illustrative example, artificial intelligence 208 is located in computer system 210 and comprises modeling 212 for training machine learning models 136. When trained using an appropriate training data set 214, one or more of machine learning models 136 can be used to identify and suggest data fields for inclusion in new report 130 based on the context 132 of new report 130.

Computer system 210 is a physical hardware system and includes one or more data processing systems. When more than one data processing system is present in computer system 210, those data processing systems are in communication with each other using a communications medium. The communications medium may be a network. The data processing systems may be selected from at least one of a computer, a server computer, a tablet, or some other suitable data processing system. When a number of processors execute instructions for a process, the number of processors can be on the same computer or on different computers in computer system 210. In other words, the process can be distributed between processors on the same or different computers in computer system 210.

As depicted, modeling 212 in artificial intelligence 208 operates to train one or more of machine learning models 136 for use in characterizing the context of reports 206. In other words, modeling 212 in artificial intelligence 208 uses existing reports 216 and logs 218 to train one or more of machine learning models 136. Collectively, existing reports 216 and logs 218 comprised training data set 214.

Each of existing reports 216 contains a title field 223, description field 224, and at least one other field selected from fields 220 that comprises a selected subset 225 of fields 220. Each of existing reports 216 corresponds to one of logs 218. Logs 218 or a record of the sequential order in which the different fields of selected subset 225 was identified for inclusion in the existing reports 216.

In one illustrative example, modeling 212 in artificial intelligence 208 operates to train one or more of machine learning models 136 for use in characterizing the context of reports 206 in a supervised learning process. During a supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

In this illustrative example, modeling 212 validates training performed on artificial intelligence 208 using validation data, which can include in and use a subset of existing reports 216. Modeling 212 analyzes the process and results of validation data to determine whether artificial intelligence 208 performs with a desired level of accuracy.

When a desired level of accuracy is reached, report management system 202 generates index 234 of the existing reports 216 according the contexts 232 determined by the modeling 212. From modeling 212, report management system 202 can predict context 132 of a new report 130. According to the index 234, Report management system 202 can identify suggested fields 242 from the existing reports 216 based on the context 132 for the new report 130. The suggested fields 242 can be presented in a graphical user interface 227 of a display system 229 of a client device, such as one or more of client devices 110 of FIG. 1.

In an illustrative example, report manager 204 identifies a subset 131 of fields 220 for inclusion in a new report 130. The subset 131 is one or more of fields 220 that has been identified by report manager 204 for inclusion in the new report 130.

In this illustrative example, report management system 202 can identify subset 131 of fields 220 in a number of different ways. For example, report management system 202 can receive user input that contains a selection of fields 220. User input can be generated by at least one of a human machine interface of an artificial intelligence system, an expert system, or some other suitable process. The human machine interface comprises an input system and a display system that enables user 124 to interact with report management system 202.

In one illustrative example, A user can select one or more of fields 220 from a list displayed in a graphical user interface. The sequential order in which the one or more fields 220 are identified for inclusion in the subset 131 defines a sequence 219.

In an illustrative example, report manager 204 determines context 132 of the new report 130. The context 132 is determined based on the subset 131 of fields 220 and the sequence 219 in which the subset 131 is identified, as recorded in logs 218.

In this illustrative example, report management system 202 can determine context 232 in a number of different ways. For example, report management system 202 can determine context 132 using one or more machine learning models 136. When trained, each of machine learning models 136 can be used to characterize the context 232 of new report 130.

In other words, report manager 204 identifies existing reports 216 and logs 218 for the existing reports 216. Each existing report 216 comprises a selected subset 225 of the data fields and each log comprising a sequence for the selected subset 225. The logs 218 and the existing reports 216 comprise a training data set 214. Report manager 204 then trains the machine learning model 136 using the training data set 214. The machine learning model is trained to determine the context 132 of the new report 130 and to determine suggested fields 242 based on the log 221 and the context 132 of the new report 130.

In this illustrative example, modeling 212 can validate training performed on artificial intelligence 208 using validation data, which can include in and use a subset of existing reports 216. Modeling 212 analyzes the process and results of validation data to determine whether artificial intelligence 208 performs with a desired level of accuracy.

In the illustrative example, report manager uses machine learning model 136 to determine a set of suggested fields 242 based on the context 132 of the new report 130. Using context 132 of the new report 130 as input to one or more machine learning models 136, report manager 204 predicts suggested fields 242 for new report 130.

For example, when a desired level of accuracy for artificial intelligence 208 is reached, report management system 202 generates index 234 of the fields 220 according to the contexts 232 of existing reports 216 as determined by the modeling 212. From modeling 212, report management system 202 can determine context 132 of a new report 130. According to the index 234, report management system 202 can predict suggested fields 242 based on the context 132 for the new report 130. The suggested fields 242 can be presented in a graphical user interface 227 of a display system 229 of a client device, such as one or more of client devices 110 of FIG. 1.

In one illustrative example, the machine learning model 136 comprises a recurrent neural network. When the machine learning model 136 is a recurrent neural network, generating the set of suggested fields 242 can include predicting suggested fields 242 according to the context 132 of the new report 130. For each suggested field predicted by the recurrent neural network, a probability density function can be computed, for example using a number of fully connected neural networks. A weighted average of the probability density functions is then calculated.

Report manager 204 then displays the set of the suggested fields 242 in a graphical user interface 227 on the display system 229. In one illustrative example, report manager 204 ranks the set of suggested fields 242 based on the weighted average of the probability density functions determined by the recurrent neural network. The ranked set of suggested fields form a ranked order. Report manager 204 displays the set of suggested fields 242 according to the ranked order.

In one illustrative example, report manager 204 makes real-time determinations of suggested fields 242 as additional fields are identified and included in the new report 130. That is, report manager 204 redetermines the context 132 of the new report 130 as fields are added to the subset 131, and the sequence 219 is updated to reflect the additions. In other words, in response to receiving a user input selecting a suggested fields 242, the report manager 204 re-determines the context 132 of the new report 130 based on the subset 131 and the sequence 219 including the suggested fields 242. Using a machine learning models 136, The report manager 204 then determines a second set of suggested fields 242 based on the redetermined context 132 of the new report 130. The report manager 204 then displays the second set of suggested fields 242 in the graphical user interface 227 on the display system 229.

Computer system 210 can be configured to perform at least one of the steps, operations, or actions described in the different illustrative examples using software, hardware, firmware or a combination thereof. As a result, computer system 210 operates as a special purpose computer system in which modeling 212 in computer system 210 enables training an artificial intelligence system to generate new reports. In the illustrative example, the use of artificial intelligence 208 in computer system 210 integrates processes into a practical application for a method of training an artificial intelligence system that increases the performance of computer system 210. In other words, artificial intelligence 208 into in computer system 210 is directed towards a practical application of processes integrated into modeling 212 in computer system 210 that identifies intentions from previously generated reports.

In this illustrative example, artificial intelligence 208 in computer system 210 utilizes existing reports 216 and logs 218 to train an artificial intelligence system using one or more machine learning algorithms in a manner that that results in an artificial intelligence system that is capable of identifying suggested fields 242 for new report 130 with a desired level of accuracy. In this manner, artificial intelligence 208 for in computer system 210 provides a practical application of a method for training an artificial intelligence system to characterize a report such that the functioning of computer system 210 is improved when using the trained artificial intelligence system.

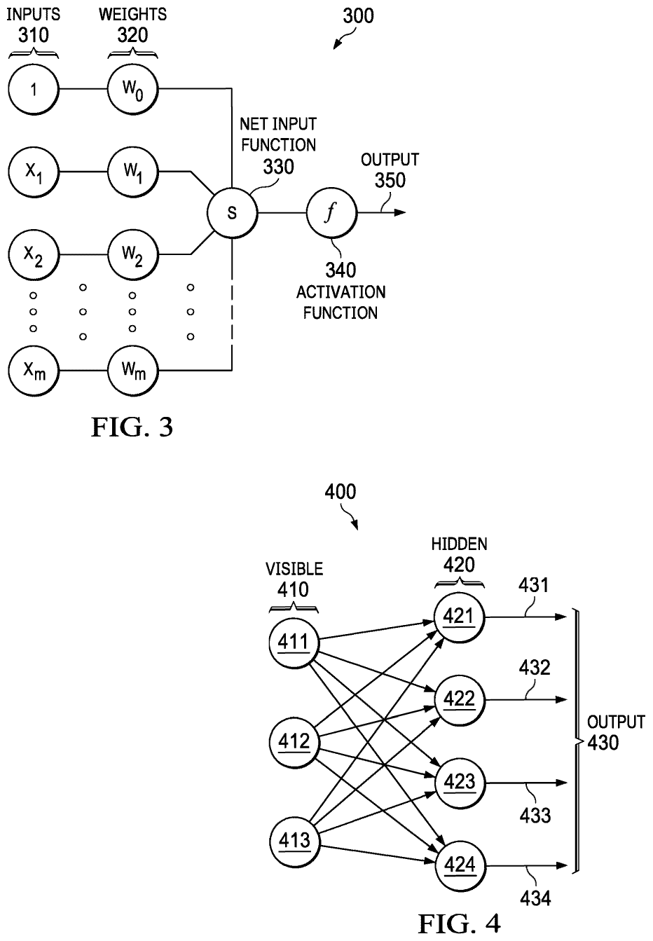

FIG. 3 is a diagram that illustrates a node in a neural network in which illustrative embodiments can be implemented. Node 300 might comprise part of artificial intelligence 208 in FIG. 2. Node 300 combines multiple inputs 310 from other nodes. Each of inputs 310 is multiplied by a respective weight 320 that either amplifies or dampens that input, thereby assigning significance to each input for the task the algorithm is trying to learn. The weighted inputs are collected by a net input function 330 and then passed through an activation function 340 to determine the output 350. The connections between nodes are called edges. The respective weights of nodes and edges might change as learning proceeds, increasing or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

FIG. 4 is a diagram illustrating a neural network in which illustrative embodiments can be implemented. Neural network 400 might comprise part of artificial intelligence 208 in FIG. 2 and is comprised of a number of nodes, such as node 300 in FIG. 3. As shown in FIG. 4, the nodes in the neural network 400 are divided into a layer 410 of visible nodes, a hidden layer 420 of hidden nodes, and a layer 430 of output nodes. Neural network 400 is an example of a fully connected neural network (FCNN) in which each node in a layer is connect to all of the nodes in an adjacent layer, but nodes within the same layer share no connections.

The visible nodes 411-413 are those that receive information from the environment (i.e. a set of external training data). Each visible node 411-413 in layer 410 takes a low-level feature from an item in the dataset and passes it to the hidden nodes in hidden layer 420. When a node in the hidden layer 420 receives an input value x from a visible node in layer 410 it multiplies x by the weight assigned to that connection (edge) and adds it to a bias b. The result of these two operations is then fed into an activation function which produces the node's output. For example, when node 421 receives input from all of the visible nodes 411-413 each x value from the separate nodes is multiplied by its respective weight, and all of the products are summed. The summed products are then added to the hidden layer bias, and the result is passed through the activation function to produce output 431. A similar process is repeated at hidden nodes 422-424 to produce respective outputs 431-434. In the case of a deeper neural network, the outputs 431-434 of hidden layer 420 serve as inputs to a next hidden layer.

The outputs 431-434 is used to output density parameters. For example, the mean and variance for the Gaussian distribution. Usually, the FCNN is used to produce classification labels or regression values. However, the illustrative embodiments use it directly to produce the distribution parameters, which can be used to estimate the likelihood/probability of output events/time. The illustrative embodiments use the FCNN to output distribution parameters, which are used to generate the bundle change event and/or event-change-time (explained below)

Training a neural network is conducted with standard mini-batch stochastic gradient descent-based approaches, where the gradient is calculated with the standard backpropagation procedure. In addition to the neural network parameters, which need to be optimized during the learning procedure, there are the weights for different distributions, which also need to be optimized based on the underlying dataset. Since the weights are non-negative, they are mapped to the range [0,1] while simultaneously requiring them summed to be 1.

In machine learning, a cost function estimates how the model is performing. It is a measure of how wrong the model is in terms of its ability to estimate the relationship between input x and output y. This is expressed as a difference or distance between the predicted value and the actual value. The cost function (i.e. loss or error) can be estimated by iteratively running the model to compare estimated predictions against known values of y during supervised learning. The objective of a machine learning model, therefore, is to find parameters, weights, or a structure that minimizes the cost function.

Gradient descent is an optimization algorithm that attempts to find a local or global minima of a function, thereby enabling the model to learn the gradient or direction that the model should take in order to reduce errors. As the model iterates, it gradually converges towards a minimum where further tweaks to the parameters produce little or zero changes in the loss. At this point the model has optimized the weights such that they minimize the cost function.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between. Each layer's output acts as the next layer's input.

Neural networks can be stacked to create deep networks. After training one neural net, the activities of its hidden nodes can be used as input training data for a higher level, thereby allowing stacking of neural networks. Such stacking makes it possible to efficiently train several layers of hidden nodes.

A recurrent neural network (RNN) is a type of deep neural network in which the nodes are formed along a temporal sequence. RNNs exhibit temporal dynamic behavior, meaning they model behavior that varies over time.

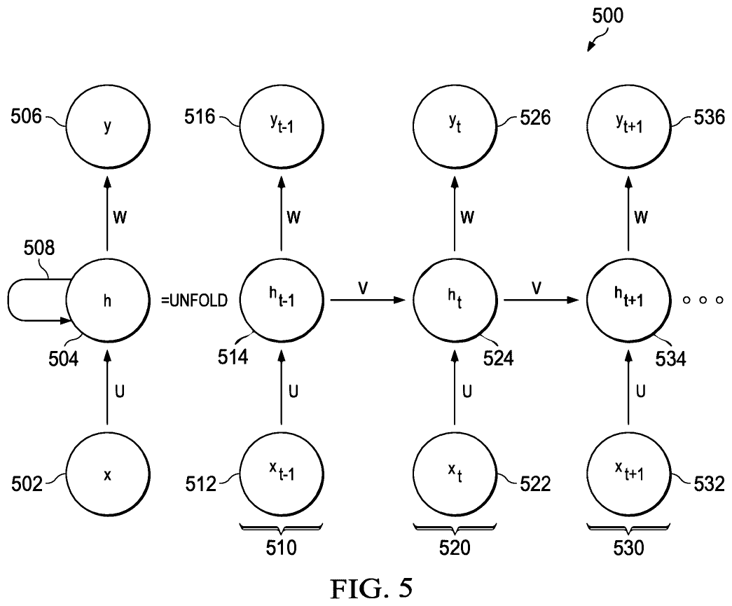

FIG. 5 illustrates an example of a recurrent neural network in which illustrative embodiments can be implemented. RNN 500 might comprise part of artificial intelligence 208 in FIG. 2. RNNs are recurrent because they perform the same task for every element of a sequence, with the output being depended on the previous computations. RNNs can be thought of as multiple copies of the same network, in which each copy passes a message to a successor. Whereas traditional neural networks process inputs independently, starting from scratch with each new input, RNNs persistence information from a previous input that informs processing of the next input in a sequence.

RNN 500 comprises an input vector 502, a hidden layer 504, and an output vector 506. RNN 500 also comprises loop 508 that allows information to persist from one input vector to the next. RNN 500 can be “unfolded” (or “unrolled”) into a chain of layers, e.g., 510, 520, 530 to write out RNN 500 for a complete sequence. Unlike a traditional neural network, which uses different weights at each layer, RNN 500 shares the same weights U, W across all steps. By providing the same weights and biases to all the layers 510, 520, 530, RNN 500 converts the independent activations into dependent activations.

The input vector 512 at time step t−1 is Xₜ₋₁. The hidden state hₜ₋₁ 514 at time step t−1, which is required to calculate the first hidden state, is typically initialized to all zeroes. The output vector 516 at time step t−1 is Yₜ₋₁. Because of persistence in the network, at the next time step t, the state hₜ 524 of the layer 520 is calculated based on the previous hidden state hₜ₋₁ 514 and the new input vector Xₜ 522. The hidden state acts as the “memory” of the network. Therefore, output Yₜ 526 at time step t depends on the calculation at time step t−1. Similarly, output vector Yₜ₊₁ 536 at time step t+1 depends on hidden state hₜ₊₁ 534, calculated from hidden state hₜ 524 and input vector Xₜ₊₁ 532.

There are several variants of RNNs such as “vanilla” RNNs, Long Short-Term Memory (LSTM), Gated Recurrent Unit (GRU), and others with which the illustrative embodiments can be implemented.

Long short-term memory (LSTM), also referred to herein as a long-short field memory network, is a type of recurrent neural network that incorporates multiplicative gates that allows the network to have long- and short-term memory. LSTM is more stable and efficient in dealing with both long-term, as well as short-term dependency problems.

An LSTM layer consists of a set of recurrently connected blocks, known as memory blocks. These blocks can be thought of as a differentiable version of the memory chips in a digital computer. Each one contains one or more recurrently connected memory cells and three multiplicative units—the input, output and forget gates—that provide continuous analogues of write, read and reset operations for the cells.

Each LSTM memory cell's internal architecture guarantees constant error ow within its constant error carrousel CEC. . . . This represents the basis for bridging very long time lags. Two gate units learn to open and close access to error ow within each memory cell's CEC. The multiplicative input gate affords protection of the CEC from perturbation by irrelevant inputs. Likewise, the multiplicative output gate protects other units from perturbation by currently irrelevant memory contents.

By employing an RNN, and more specifically an LSTM, the illustrative embodiments are able to model changes in context for reports based on the sequence and selection of fields incorporated into the report.

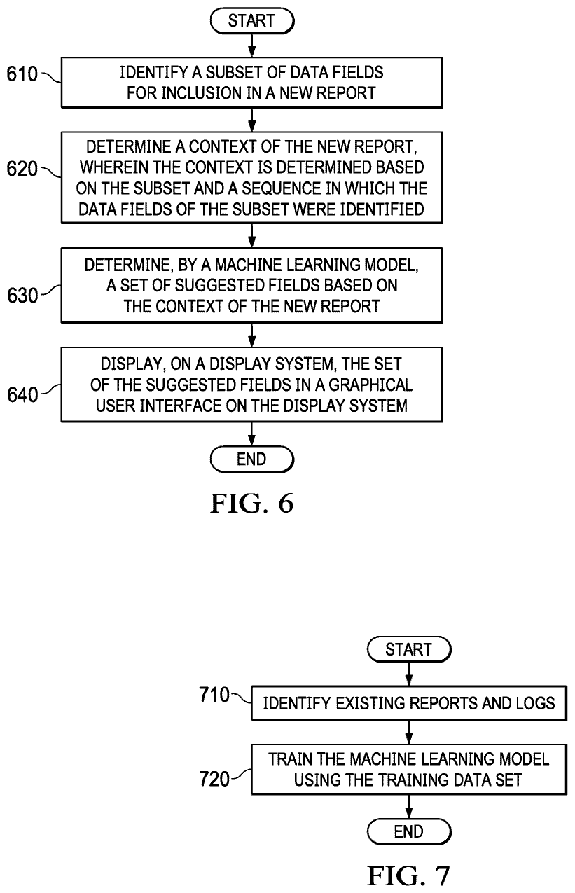

With reference next to FIG. 6, a flowchart illustrating a process for managing reports is depicted in accordance with an illustrative embodiment. The process of FIG. 6 can be implemented in one or more components of computer system 210 of FIG. 2, such as in report manager 204 of FIG. 2.

The process begins by identifying a subset of data fields for inclusion in a new report (step 610). In one illustrative example, the process identifies the subset of data fields by receiving the subset of data fields in a user input generated by at least one of a human machine interface or artificial intelligence system. The subset is selected from data fields of human resources information generated in providing human resource services.

The process determines a context of the new report, wherein the context is determined based on the subset and a sequence in which the data fields of the subset were identified (step 620). Using a machine learning model, The process determines a set of suggested fields based on the context of the new report (step 630). The process displays the set of the suggested fields in a graphical user interface on the display system (step 640), and terminates thereafter.

With reference next to FIG. 7, a process for modeling existing reports is depicted according to an illustrative example. The process of FIG. 7 can be implemented in one or more components of computer system 210 of FIG. 2, such as in report manager 204 of FIG. 2. The process of FIG. 7 can be used to train one or more machine learning models. The machine learning models can then be used in a process of managing reports, such as process 600 of FIG. 6.

The process begins by identifying existing reports and logs for the existing reports (step 710). Each existing report comprises a selected subset of the data fields. Each log comprises a sequence for the selected subset. The logs and the existing reports comprise a training data set.

The process trains the machine learning model using the training data set (step 720), and terminates thereafter. The machine learning model is trained to determine the context of the new report and to determine the set of suggested fields based on the log and the context. Process 600 of FIG. 6 can determine the set of suggested fields using the models trained according to process 700.

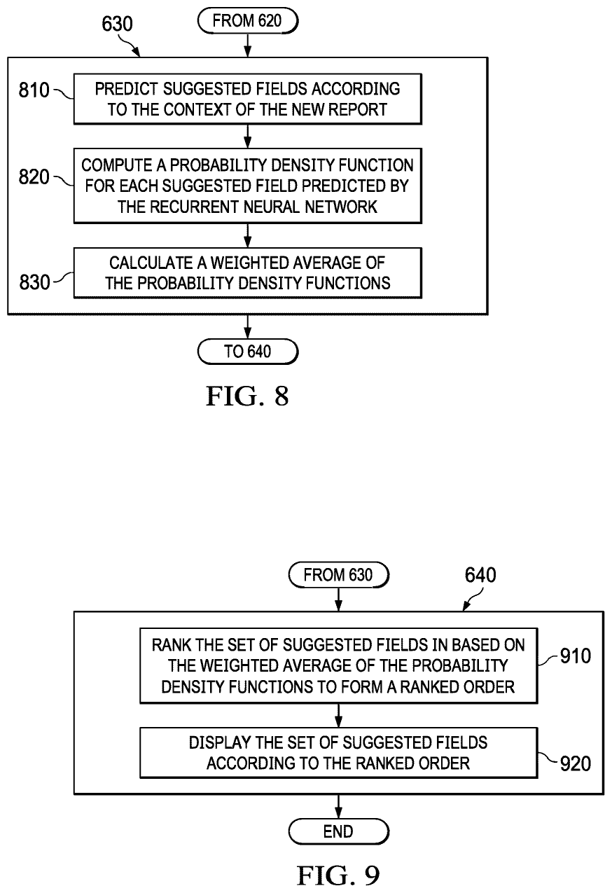

With reference next to FIG. 8, a process for generating a set of suggested fields using a recurrent neural network is shown according to an illustrative example. The process of FIG. 8 is one example in which process step 630 of FIG. 6 can be implemented.

Using the recurrent neural network, process 800 predicts suggested fields according to the context of the new report (step 810). Using a number of fully connected neural networks, process 800 computes a probability density function for each recommended field predicted by the recurrent neural network (step 820). The process calculates a weighted average of the probability density functions (step 830), and terminates thereafter.

With reference next to FIG. 9, a process for displaying a set of suggested fields is shown according to an illustrative example. The process of FIG. 9 is one example in which process step 640 of FIG. 6 can be implemented.

The process ranks the set of suggested fields in based on the weighted average of the probability density functions to form a ranked order (step 910). The process displays the set of suggested fields according to the ranked order (step 920), and terminates thereafter.

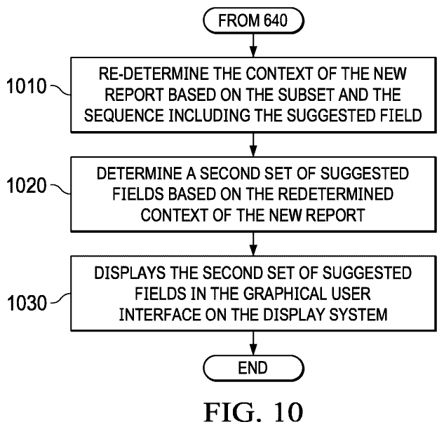

With reference next to FIG. 10, a process for generating a set of suggested fields in real time is shown according to an illustrative example. The process of FIG. 10 is one example in which process FIG. 6 can be implemented.

Continuing from step 640, in response to receiving a user input selecting a suggested field, the process re-determines the context of the new report based on the subset and the sequence including the suggested field (step 1010). Using a machine learning model, the process determines a second set of suggested fields based on the redetermined context of the new report (step 1020). The process displays the second set of suggested fields in the graphical user interface on the display system (step 1030), and terminates thereafter.

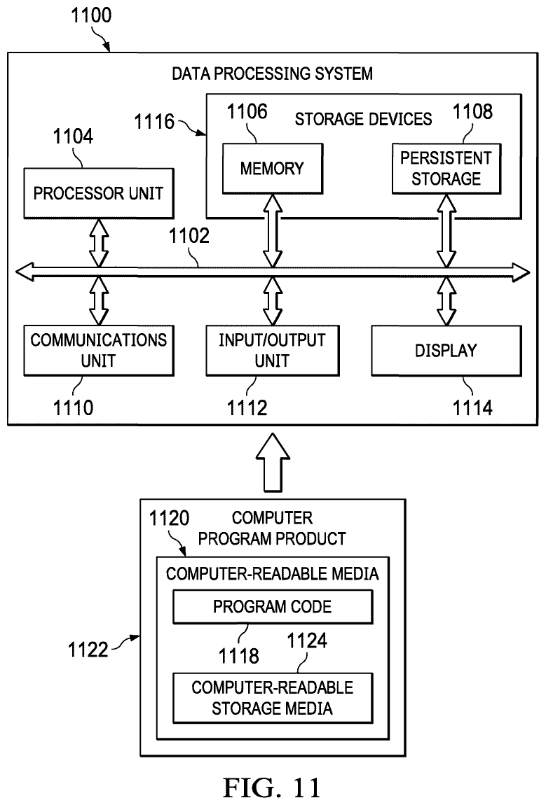

Turning now to FIG. 11, an illustration of a block diagram of a data processing system is depicted in accordance with an illustrative embodiment. Data processing system 1100 may be used to implement one or more computers and client computer 112 in FIG. 1. In this illustrative example, data processing system 1100 includes communications framework 1102, which provides communications between processor unit 1104, memory 1106, persistent storage 1108, communications unit 1110, input/output unit 1112, and display 1114. In this example, communications framework 1102 may take the form of a bus system.

Processor unit 1104 serves to execute instructions for software that may be loaded into memory 1106. Processor unit 1104 may be a number of processors, a multi-processor core, or some other type of processor, depending on the particular implementation. In an embodiment, processor unit 1104 comprises one or more conventional general-purpose central processing units (CPUs). In an alternate embodiment, processor unit 1104 comprises one or more graphical processing units (GPUs)

Memory 1106 and persistent storage 1108 are examples of storage devices 1116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1116 may also be referred to as computer-readable storage devices in these illustrative examples. Memory 1106, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a flash memory, a rewritable optical disk, a rewritable magnetic tape, or some combination of the above. The media used by persistent storage 1108 also may be removable. For example, a removable hard drive may be used for persistent storage 1108. Communications unit 1110, in these illustrative examples, provides for communications with other data processing systems or devices. In these illustrative examples, communications unit 1110 is a network interface card.

Input/output unit 1112 allows for input and output of data with other devices that may be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs may be located in storage devices 1116, which are in communication with processor unit 1104 through communications framework 1102. The processes of the different embodiments may be performed by processor unit 1104 using computer-implemented instructions, which may be located in a memory, such as memory 1106.

These instructions are referred to as program code, computer-usable program code, or computer-readable program code that may be read and executed by a processor in processor unit 1104. The program code in the different embodiments may be embodied on different physical or computer-readable storage media, such as memory 1106 or persistent storage 1108.

Program code 1118 is located in a functional form on computer-readable media 1120 that is selectively removable and may be loaded onto or transferred to data processing system 1100 for execution by processor unit 1104. Program code 1118 and computer-readable media 1120 form computer program product 1122 in these illustrative examples. In one example, computer-readable media 1120 may be computer-readable storage media 1124 or computer-readable signal media 1126.

In these illustrative examples, computer-readable storage media 1124 is a physical or tangible storage device used to store program code 1118 rather than a medium that propagates or transmits program code 1118. Alternatively, program code 1118 may be transferred to data processing system 1100 using computer-readable signal media 1126.

Computer-readable signal media 1126 may be, for example, a propagated data signal containing program code 1118. For example, computer-readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

The illustrative embodiments described herein provide a computer-implemented a method, computer system, and computer program product for generating reports. A subset of data fields is identified for inclusion in a new report. A context of the new report is determined based on the subset and a sequence in which the data fields of the subset were identified. Using a machine learning model, a set of suggested fields is determined based on the context of the new report. The set of the suggested fields in a graphical user interface on a display system.

Therefore, the illustrative embodiments described herein provide a technical solution to the technical problem of generating reports provides a technical effect in which a new reports are generated more easily and quickly while requiring less knowledge or training from an operator.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A system, comprising:
one or more processors, coupled with memory, to:
receive, via a graphical user interface, an input to identify a subset of data fields for inclusion into an electronic data structure;
identify a sequential order in which the data fields of the subset are selected via the graphical user interface for inclusion into the electronic data structure;
execute computer code instructions to determine, using a trained machine learning model comprising a long-short term memory neural network configured to probabilistically determine data fields based on contexts generated from sequentially ordered selected data fields, a context of the electronic data structure based on the identified subset of data fields and the sequential order in which the subset was identified by the input;
identify, using the determined context, an index corresponding to an existing electronic data structure stored in a data storage, wherein the existing electronic data structure includes one or more additional data fields identified by the trained machine learning model to present for selection via the graphical user interface;
retrieve, from the data storage using the index, one or more values corresponding to the one or more additional data fields of the existing data structure;
include, in the electronic data structure, the one or more additional data fields and the one or more retrieved values corresponding to the one or more additional data fields to create an updated electronic data structure;
cause display of the one or more additional data fields for the updated electronic data structure via the graphical user interface;
generate, responsive to a selection of an additional data field of the one or more additional data fields via the graphical user interface, the updated electronic data structure including the selected additional data field and a retrieved value of the one or more retrieved values corresponding to the selected additional data field; and
cause display of the updated electronic data structure in accordance with the selection, via the graphical user interface.

2. The system of claim 1, wherein the one or more processors further:
determine the context of the electronic data structure based on an analysis of the identified subset of data fields and the sequential order input into the trained machine learning model.

3. The system of claim 1, wherein the one or more processors further:
access one or more indexes storing existing electronic data structures according to contexts determined by the trained machine learning model; and
identify the existing electronic data structure based on the determined context of the electronic data structure based on the index of the one or more indexes.

4. The system of claim 1, wherein the trained machine learning model comprises a plurality of recurrent hidden layers, each hidden layer of the plurality of recurrent hidden layers comprising one or more memory cells that are recurrently connected and include one or more units that provide operations that are analogous to write, read and reset operations for information corresponding to the context.

5. The system of claim 4, wherein the one or more processors further:
execute, via the plurality of recurrent hidden layers, on the one or more units corresponding to the one or more memory cells, one of: an operation of an input unit to protect the information corresponding to the context from perturbation by inputs, an operation of an output unit to control providing the information corresponding to the context from the one or more memory cells and an operation of a forget gate to selectively reset or erase the information corresponding to the context.

6. The system of claim 1, wherein the trained machine learning model is configured to update, via machine learning based on existing electronic data structures, a log that records the sequential order in which data fields were identified by user input for inclusion in the existing electronic data structures.

7. The system of claim 1, wherein the trained machine learning model comprises a neural network including a plurality of fully connected neural network layers configured to output one or more probability density functions that are used to estimate one or more likelihoods of inclusion of the one or more additional data fields into the electronic data structure.

8. The system of claim 7, wherein the machine learning model is further configured to determine, using the fully connected neural network layers, a weighted average of the one or more probability density functions, and the one or more processors further determine the one or more additional data fields for inclusion into the electronic data structure using the weighted average.

9. The system of claim 1, wherein the one or more processors further:
retrieve the one or more values corresponding to the one or more additional data fields based on a map that associates each of the one or more additional data fields with respective fields of existing electronic data structures stored in the data storage.

10. The system of claim 1, wherein the one or more processors further:
store, in a storage device, one or more indexes that associate each of a plurality of existing electronic data structures with contexts previously determined by the trained machine learning model for the plurality of existing electronic data structures; and
identify, from the plurality of existing electronic data structures, the existing electronic data structure according to the stored index based on the context determined for the electronic data structure.

11. The system of claim 1, wherein the one or more processors further:
execute the trained machine learning model with a validation data set comprising a subset of a plurality of existing electronic data structures corresponding to the index; and
validate the trained machine learning model to achieve a predetermined accuracy level based on applying the trained machine learning model to the validation data set.

12. The system of claim 1, wherein the trained machine learning model comprises a recurrent neural network having long-short term memory neural network layers configured to store information from previously identified sequential orders and subsets of data fields.

13. The system of claim 1, wherein the data storage includes one or more relational database tables including columns corresponding to data fields comprising the one or more additional data fields, and wherein retrieving the one or more values comprises retrieving stored values from the one or more relational database tables using columns identified based on the one or more additional data fields.

14. A method, comprising:
receiving, by one or more processors coupled with memory, via a graphical user interface, an input to identify a subset of data fields for inclusion into an electronic data structure;
identifying, by the one or more processors, a sequential order in which the data fields of the subset are selected via the graphical user interface for inclusion into the electronic data structure;
executing, by the one or more processors, computer code instructions to determine, using a trained machine learning model comprising a long-short term memory neural network configured to probabilistically determine data fields based on contexts generated from sequentially ordered selected data fields, a context of the electronic data structure based on the identified subset of data fields and the sequential order in which the subset was identified by the input;
identifying, by the one or more processors, using the determined context, an index corresponding to an existing electronic data structure stored in a data storage, wherein the existing electronic data structure includes one or more additional data fields identified by the trained machine learning model to present for selection via the graphical user interface;
retrieving, by the one or more processors, from the data storage using the index, one or more values corresponding to the one or more additional data fields of the existing data structure;
including, by the one or more processors, in the electronic data structure with the one or more additional data fields and the one or more retrieved values corresponding to the one or more additional data fields to create an updated electronic data structure;
causing, by the one or more processors, display of the one or more additional data fields for the updated electronic data structure via the graphical user interface;
generating, by the one or more processors, responsive to a selection of an additional data field of the one or more additional data fields via the graphical user interface, the updated electronic data structure including the selected additional data field and a retrieved value of the one or more retrieved values corresponding to the selected additional data field; and
causing, by the one or more processors, display of the updated electronic data structure in accordance with the selection, via the graphical user interface.

15. The method of claim 14, comprising determining, by the one or more processors, the context of the electronic data structure based on an analysis of the identified subset of data fields and the sequential order input into the trained machine learning model.

16. The method of claim 14, comprising:
accessing, by the one or more processors, one or more indexes storing existing electronic data structures according to contexts determined by the trained machine learning model; and
identifying, by the one or more processors, the existing electronic data structure based on the determined context of the electronic data structure based on the index of the one or more indexes.

17. The method of claim 14, wherein the trained machine learning model comprises a plurality of recurrent hidden layers, each hidden layer of the plurality of recurrent hidden layers comprising one or more memory cells that are recurrently connected and include one or more units that provide operations that are analogous to write, read and reset operations for information corresponding to the context.

18. The method of claim 17, comprising:
executing, by the one or more processors, via the plurality of recurrent hidden layers, on the one or more units corresponding to the one or more memory cells, one of: an operation of an input unit to protect the information corresponding to the context from perturbation by inputs, an operation of an output unit to control providing the information corresponding to the context from the one or more memory cells and an operation of a forget gate to selectively reset or erase the information corresponding to the context.

19. The method of claim 14, comprising: updating, by the one or more processors using the trained machine learning model and based on existing electronic data structures, a log that records the sequential order in which data fields were identified by user input for inclusion in the existing electronic data structures.

20. A non-transitory computer readable media storing instructions that, when executed by one or more processors, cause the one or more processors to:
receive, via a graphical user interface, an input to identify a subset of data fields for inclusion into an electronic data structure;
identify a sequential order in which the data fields of the subset are selected via the graphical user interface for inclusion into the electronic data structure;
execute computer code instructions to determine, using a trained machine learning model comprising a long-short term memory neural network configured to probabilistically determine data fields based on contexts generated from sequentially ordered selected data fields, a context of the electronic data structure based on the identified subset of data fields and the sequential order in which the subset was identified by the input;
identify, using the determined context, an index corresponding to an existing electronic data structure stored in a data storage, wherein the existing electronic data structure includes one or more additional data fields identified by the trained machine learning model to present for selection via the graphical user interface;
retrieve, from the data storage using the index, one or more values corresponding to the one or more additional data fields of the existing data structure;
include, in the electronic data structure, the one or more additional data fields and the one or more retrieved values corresponding to the one or more additional data fields to create an updated electronic data structure;
cause display of the one or more additional data fields for the updated electronic data structure via the graphical user interface;
generate, responsive to a selection of an additional data field of the one or more additional data fields via the graphical user interface, the updated electronic data structure including the selected additional data field and a retrieved value of the one or more retrieved values corresponding to the selected additional data field; and
cause display of the updated electronic data structure in accordance with the selection, via the graphical user interface.
